(19) United States
(12) Patent Application Publication
(10) Pub. No.: US 2007/0014899 A1
(43) Pub. Date: Jan. 18, 2007

(54) Fa-resistant textile gut

(76) Inventor: Peter Wolf, Ostercappeln (DE)

Correspondence Address: BAKER DONELSON BEARMAN CALDWELL & BERKOWITZ, PC, 555 11TH STREET, NW, 6TH FLOOR, WASHINGTON, DC, 20004, US

(21) Appl. No.: 10/555,197

(22) PCT Filed: Mar. 3, 2004
(86) PCT No.: PCT/EP04/04645

§ 371 Date: Nov. 1, 2005

(30) Foreign Application Priority Data
May 5, 2003 (DE) 103 20 168.8

(51) Int. Cl. A22C 13/00

(52) U.S. Cl. 426/135

(57) ABSTRACT

A textile skin is disclosed which has at least one longitudinal seam and which comprises a textile material and a fat-tight film, preferably a plastic film. This film is connected to the inside of the textile material in a two-dimensional manner such that it forms a projection over the longitudinal seam and the edge of the textile material. In the region of the projection the film is closed in a fat-tight manner. The textile skin is used especially as artificial sausage casing, in particular for raw sausages having a high fat content.

The invention relates to a textile skin having at least one longitudinal seam, a method for its production and also to its use as food casing, especially as artificial sausage casing.

Food casings made of textile material are already known. They comprise, for example, a protein-coated fabric framework. In this case, first a (seamless) textile hollow tubing made of cotton, synthetic or silk fibers is produced. This is divided into certain lengths which are then taken up onto a tube conducting compressed air. From there the partial lengths are passed through an apparatus in which a collagen protein composition is applied to the surface of the tubing. The amount applied is such that the gaps in the fabric are closed. Excess protein composition is taken off by a doctor knife. The protein-coated fabric framework skin is permeable to water vapor and is therefore suitable for producing sliceable raw sausage varieties (G. Effenberger, Wursthüillen—Kunstdarm [Sausage Casings—Artificial Skin], 2nd Ed. [1991], Holzmann Buchverlag, Bad Wörishofen, pp. 25 and 106-108).

Smokeable acrylic-coated textile skins are also known (DE A 31 47 519). The textile base material used therein can be a consolidated nonwoven, a spunbonded fabric or a fabric made of natural fibers and/or artificial fibers. Those which are mentioned are fibers of cotton, linen, wool, silk, cellulose ester, regenerated cellulose, polyester, polyamide, polyacrylonitrile, polypropylene and poly(vinyl chloride). The base material is coated with an acrylic emulsion polymer based on lipophilic esters of (meth)acrylic acid with lower alkanols, in particular butyl acrylate. The coating is applied using customary coating apparatuses, such as an air knife, knife-roll coater, knife-blanket coater etc. By appropriate choice of coating, the acrylic-coated textile skin can be made permeable to water vapor and gas, so that it is also suitable for long-keeping sausage.

An important disadvantage of the known textile skins is that they are not fat-tight. Textile skins are frequently used for spreadable, possibly cold-smoked, raw sausages having a very high fat content. In particular in the vicinity of the seam, fat then penetrates to the outside which becomes unpleasantly noticeable on handling the sausage. Because of the insufficient tightness, furthermore, microorganisms (e.g. Listeria) can pass into the sausage emulsion and spoil it.

An artificial sausage casing which is smokeable with limitations and is in a natural skin form is disclosed in DE-A 199 42 835. It is produced from two appropriately shaped flat films which are laid one over the other and glued, stitched or welded at the edges. The films themselves preferably comprise high density polyethylene. After the welding, a support material can be drawn over the plastic material of the casing. The casing material is not connected to the support material. Textile materials are not described, also not for the support material.

The object was therefore to improve the known textile skins in such a manner that they become fat-tight and thus can also be used for foods having a high fat content. The textile skin to be developed is furthermore to be as impermeable as possible to microorganisms. Depending on the intended use, it is to be permeable or impermeable to water vapor, oxygen and/or smoke constituents. In addition, it is to have sufficient mechanical stability and also be able to be produced in curved or irregular natural-skin-like shapes.

The object was achieved by a textile skin having at least one longitudinal seam, wherein it comprises a textile material and a fat-tight film, the film being connected to the inside of the textile material in a two-dimensional manner such that it forms a projection over the longitudinal seam and the edge of the textile material and is closed in a fat-tight manner in the region of the projection. A textile skin is thus provided which is also effectively sealed at the site where the textile material having a stitched seam is joined. Exit of fat, water or other constituents of the food can thus be reliably prevented.

The longitudinal edges of the inner film always project beyond the textile material, so that they can be joined firmly and in a fat-tight manner to one another by sealing, glueing, cold- or hot-welding or by other joining methods.

In a preferred embodiment, the textile skin has two longitudinal seams. The internal film is expediently likewise composed of two halves which, at the projecting longitudinal edges, are in each case joined to one another in a fat-tight manner.

The textile material comprises as base material a woven fabric, loop-formingly knitted fabric, consolidated nonwoven or spunbonded fabric made of natural fiber, synthetic fibers or mixtures thereof. Suitable natural fibers are, for example, cotton fibers, cellulose fibers (for example linen), wool or silk. Suitable synthetic fibers are, for example, made of polyamide, polyester, polyolefin (especially polypropylene), regenerated cellulose (=viscose staple), poly(vinyl acetate), polyacrylonitrile or poly(vinyl chloride) or of the corresponding copolymers. Particular preference is given to a thin, longitudinally and transversely stretched fabric made of cotton, viscose staple or a mixture of cotton and polyester, cotton and viscose staple, or viscose staple and polyester. Preferably it has a weight per unit area of 8 to 300 g/m², preferably 20 to 150 g/m², particularly preferably 45 to 120 g/m².

Preferably, the base material is coated on one or both sides (also dip-coated=foulard-coated) or is surface-treated in another manner. Suitable coating materials are particularly acrylic resins and plastic blends, especially emulsion polymers based on (C₁-C₆)alkyl (meth)acrylates, in particular butyl (meth)acrylate. The term (meth)acrylate here as customary means acrylate and/or methacrylate. Units of other monomers can occur, for example those of styrene, α-methylstyrene or vinyl acetate.

The fraction of units of such other monomers should not exceed 25% by weight, preferably 15% by weight. Suitable acrylic resins are known to those skilled in the art, in particular from DE A 31 47 519. Suitable materials for coating the base material are, in addition, poly(vinyl acetate), silicone dispersions, mixtures of acrylates with poly(vinyl acetate)s, mixtures of silicones with acrylates and poly(vinyl acetate)s and also viscose which is then regenerated to form cellulose, and other coating liquids which comprise cellulose in derivatized or non-derivatized form, these if appropriate being blended with acrylics. The base material can alternatively be coated by collagen fibers, especially with beef collagen fibers. A material already coated with acrylic can be additionally coated with collagen. The thickness of the coating is selected in such a manner that the water vapor permeability and oxygen permeability required for ripening the sausage is still present. A plurality of layers can also be applied. Suitable methods and apparatuses for coating are known in principle to those skilled in the art. The coating can virtually fill all the interstitial spaces between the fibers. In order to achieve a particularly “textile” appearance, if appropriate not all interstitial spaces between the fibers are filled. The base material, and also the material used for coating or impregnation, can also be colored by dyes and/or color pigments. Instead of this, or in addition, the coated or impregnated flat textile material can further be printed, preferably in a flexographic printing method.

During or after coating, the base material is expediently stretched in the longitudinal and transverse directions. The extent of the stretching is dependent, inter alia, on the weight per unit area, on the construction and on the type of the material. The area stretching ratio is generally 1 to 20% in the longitudinal and transverse directions, preferably 3 to 15%, in each case based on the untreated material dimension. In the case of a light cotton or viscose staple woven fabric or a mixed woven fabric of cotton and polyester, cotton and viscose staple, or viscose staple and polyester having a weight per unit area of 45 to 120 g/m², for example, it is stretched about 3 to 5% over the initial length or width. If stretching is omitted, the textile material remains particularly elastic and is therefore particularly suitable for producing a textile skin for irregularly shaped products such as cooked cured goods, in particular cooked ham.

The film on the inside of the inventive composite material is a single-layered or multi-layered film, preferably a hot-sealable or weldable film, particularly preferably a mono- or biaxially stretched film.

In particular it is a plastic film made of a polyolefinic material, for example of polyethylene or polypropylene (especially high-density polyethylene). Since the film is not exposed to high mechanical loads, it can be relatively thin. A thickness of 5 to 200 μm, preferably of 8 to 50 μm, particularly preferably of 10 to 30 μm, has proved to be expedient. If the inventive casing is to be smokeable, the film then expediently essentially comprises a swellable, polar polymer, for example a polyesteramide. Suitable films for a smokeable casing are, in addition, films based on aliphatic polyamides, for example those which comprise a mixture of aliphatic (co)polyamide and glycol- or polyglycol-modified aliphatic and/or partially aromatic (co)polyamide. The term (co)polyamide here means polyamide and/or copolyamide. By means which cause small bubbles or vacuoles in the film (without causing holes in the film through which the fat could escape), the permeability for smoke constituents can be further increased. Furthermore, films made of natural fibers, for example collagen fibers, are suitable. Finally, use can also be made of films of, preferably edible, natural high-molecular-weight substances such as carrageenan, alginate, pullulan, starch, starch derivatives (e.g. starch acetate), proteins (e.g. casein) or polylactide.

The inner film is in every case intended for contact with the food, especially with the sausagemeat emulsion. It is therefore also to ensure an appropriate emulsion adhesion, so that the casing firstly does not detach from the sausagemeat emulsion during storage, but secondly can be removed without problems by the consumer. The emulsion adhesion may be influenced, for example, by subjecting the surface of a plastic film to a corona treatment. In individual cases it can also be expedient to apply one of the customary release and/or adhesion preparations to the film in order to set the emulsion adhesion to the correct extent.

The aliphatic polyamide or copolyamide of the inner film is preferably poly(ε-caprolactam), poly(hexamethylene adipamide), a copolyamide of hexamethylenediamine and dodecanedioic acid (=nylon 6.12) or polyamide 6/6.6.

In a further embodiment, on one side of the flat textile material, a film is applied, e.g. by laminating, glueing or lining. This film can also be printed, e.g. in a flexographic method. It is then expediently laminated in such a manner that the printed picture is on the underside and visible through the, generally transparent, film. This has the advantage that the printed picture cannot smear. This film which is only present if appropriate is present on the outside in the inventive composite. In order not to impair the textile impression too greatly, it should be relatively thin (about 5 to 150 μm, preferably about 20 to 60 μm). The film itself can comprise virtually any material, for example polyester, polyamide (nylon), polyolefin and/or ethylene/vinyl alcohol-copolymer (EVOH) and also customary additives. They can be unstretched or stretched, single- or multi-layered. The stretched films can also be shrinkable. Three-layer films have, for example, a structure nylon/(PE+adhesion promoter)/nylon or nylon/EVOH/nylon.

The inventive casing can have irregular contours and by this means imitate the shape of a natural skin, for example of what is termed a fat end.

The inventive composite material can expediently be produced by a method which comprises the following steps:
a) providing an if appropriate coated flat textile material;
b) if appropriate printing the flat material, for example in a separate working step or in an in-line method. In the case of a transparent coating, the flat material can also be printed before the coating. Printing can also be performed onto a foulard-coated flat material, or flat material provided with only a base coat, for example in a rotogravure, screenprinting or flexographic method.
c) superimposing two webs of the if appropriate coated flat textile material, the later outsides of the inventive composite lying one over the other; or corresponding folding of the flat material in the longitudinal direction. The webs can have straight, curved or irregularly shaped edges. In the two latter cases, the two webs are formed as mirror images of each other.
d) joining the longitudinal edges of the flat textile material by a seam, preferably a stitched seam. The seam can run in a straight line, curved or irregularly (e.g. to imitate the shape of a natural skin). It can be, for example, an overedge stitch seam, a chain-stitch seam or double-chain stitch seam or a lock stitch seam. It can also be a single peripheral seam. During stitching, the longitudinal edges are if appropriate cut so that from a straight edge produced by folding a stitched edge having substantially any desired shape can be produced.
e) providing a fat-tight film;
f) joining in a two-dimensional manner one web each of the film to the upper side and lower side of the flat textile material joined by at least one seam. The joining is performed, for example, by glueing, sealing (cold or hot, with or without hotmelt), lining or laminating. The film projects here laterally over the flat textile material. If it is expedient or required, the web can likewise be cut from the film, e.g. to adapt its shape to that of the flat textile material. The film can also be, before the lamination, cut into the desired shape, for example into the shape of a “fat end”.
g) joining the overlapping edges of the film to one another. This can, depending on the type of the film, be performed by hot-sealing, glueing, welding or in another manner. The steps e) and f) can also be combined to form a single step.
h) if appropriate cutting the composite material produced into sections, a section in each case corresponding to a sausage length (preferably about 10 to 100 cm). The cutting can alternatively also be performed during stuffing.
i) reversing the sections, so that the seam projects inwards and the film is situated on the inside. The reversal can also be performed before cutting, i.e. before step h).
j) if appropriate closing one end of each section, for example by a metal clip, a yarn tie or the like. If the film can be sealed, the closing can also be performed by welding. The end is closed in a fat-tight manner by this means. A yarn loop or other suspender for a sausage can also be associated with this.
k) if appropriate shirring the composite material to form a shirred stick.

Alternatively to this, a composite material can also be produced in which the flat textile material is joined by a longitudinal seam on only one side. The flat material is then correspondingly folded in advance in a longitudinal direction. Then, as described, in each case a film can be applied from both sides and joined in a two-dimensional manner. The side edges of the films are joined to one another. The composite material is then turned inside out as described.

The examples hereinafter serve to illustrate the invention.

### EXAMPLE 1

A 68/68-30/30(NE) woven fabric made of a mixture of cotton and polyester (55:45% by weight) having a weight of 120 g/m² was coated repeatedly with an acrylic dispersion using a doctor knife. After drying, the coating had a weight of about 65 g/m². The coated flat textile material was then printed in-line over the full surface on one side, in order to give it an appearance which imitates that of a natural skin. Two webs of the flat textile material cut to a corresponding width were laid one over the other with the printed sides facing one another. The edges were then stitched (in which case the seam was about 2 to 3 mm from the edge). Then, onto the outside of the two textile webs, in each case a 25 μm thick film of high density polyethylene was glued by a polyurethane glue and thus firmly joined. The width of the film webs projected beyond the width of the flat textile material on each side by about 2 mm. These projecting film edges were then joined to one another in a fat-tight manner by glueing using a polyurethane glue. The casing was then turned inside out so that the stitched seam and also the glued seam faced inwards. Thereafter the casing was cut into sections of predetermined length and one end of each of the sections was closed by a metal clip. The metal clip simultaneously held a yarn loop for suspending the sausage. The casing was stuffed with liver sausage emulsion, clipped and hot smoked.

The finished sausage was stored for 14 days without problems, without infestation by microorganisms being observed or the emulsion being impaired in any manner.

### EXAMPLE 2

Example 1 was repeated with the single deviation that a wider flat textile material was used which had been folded once in the longitudinal direction. The folded material was stitched on both sides, the folded edge being cut during stitching. In this manner, it was possible to ensure particularly simply that no shifting of the printing pattern between the front side and rear side of the sausage casing occurs.

1. A textile skin having at least one longitudinal seam, wherein said skin comprises a textile material and a fat-tight film, the film being connected to an inside portion of the textile material in a two-dimensional manner such that said film forms a projection over the longitudinal seam and an edge of the textile material, and is closed in a fat-tight manner in a region of the projection.

2. The textile skin as claimed in claim 1, wherein the film is closed by sealing, gluing and/or welding.

3. The textile skin as claimed in claim 1, wherein said skin has two longitudinal seams.

4. The textile skin as claimed in claim 1, wherein said skin comprises a woven fabric, loop-formingly knitted fabric, consolidated nonwoven or spunbonded fabric made of natural fiber, synthetic fibers or mixtures thereof.

5. The textile skin as claimed in claim 4, wherein the woven fabric comprises cotton and/or viscose staple, the cotton and/or viscose staple optionally being mixed with synthetic fibers.

6. The textile skin as claimed in claim 5, wherein the woven fabric has a weight per unit area of 8 to 300 g/m².

7. The textile skin as claimed in claim 4, wherein the woven fabric, loop-formingly knitted fabric, consolidated nonwoven or spunbonded fabric is coated on one or both sides and/or is otherwise surface-treated.

8. The textile skin as claimed in claim 7, wherein the film is a single-layered or multi-layered film.

9. The textile skin as claimed in claim 8, wherein the film is essentially made of polyolefin, of natural fibers, and/or of natural high-molecular-weight substances.

10. The textile skin a claimed in claim 1, wherein the film has a thickness of 5 to 200 μm.

11. The textile skin as claimed in claim 1, wherein edges thereof have irregular contours and simulate a shape of a natural skin.

12. The textile skin as claimed in claim 1, wherein said skin is connected by an outside portion thereof to a second film.

13. The textile skin as claimed in claim 12, wherein the film situated on the outside is printed.

14. A method for producing a textile skin as claimed in claim 1, comprising:
a) providing an optionally coated flat textile material;
b) optionally printing the flat material;
c) superimposing two webs of the flat textile material, wherein outside portions thereof lie one over the other;
d) joining longitudinal edges of the flat textile material by a seam;
e) providing a fat-tight film;
f) joining in a two-dimensional manner, one web each of the film to an upper side and a lower side of the flat textile material joined by a seam such that the film projects laterally over the flat textile material;
g) joining overlapping edges of the film to one another;
h) optionally cutting the composite material produced into sections, a section in each case corresponding to a sausage length;
i) reversing the sections, so that the seam projects inwardly and the film is situated on an inside portion thereof;
j) optionally closing one end of each section; and
k) optionally shirring the composite material to form a shirred stick.

15. A method for making a casing for raw sausages, cooked-meat sausages or scaled-emulsion sausages comprising:
obtaining a textile skin of claim 1 and
forming said skin into said casing.

16. A textile skin of claim 5, wherein said synthetic fibers comprise polyester and/or polyamide.

17. A textile skin of claim 5, wherein the woven fabric has a weight per unit area of 20-150 g/m².

18. A textile skin of claim 8, wherein said film is a weldable and/or hot sealable film and/or a mono- or biaxially stretched film.

19. A textile skin of claim 10, wherein said film has a thickness of 8-50 μm.

20. A textile skin of claim 13, wherein said printing is on a side of the film facing the textile material.
